(19) United States
(12) Patent Application Publication
(10) Pub. No.: US 2014/0236412 A1
(43) Pub. Date: Aug. 21, 2014

(54) APPARATUS AND METHOD FOR AUTOMATICALLY PARKING VEHICLE

(71) Applicant: Electronics and Telecommunications Research Institute, Daejeon-city (KR)

(72) Inventors: Kyung-Bok SUNG, Daejeon (KR); Kyoung-Wook MIN, Daejeon (KR); Jeong-Dan CHOI, Daejeon (KR); Seung-Jun HAN, Daejeon (KR)

(73) Assignee: Electronics and Telecommunications Research Institute, Daejeon-city (KR)

(21) Appl. No.: 14/146,109

(22) Filed: Jan. 2, 2014

(30) Foreign Application Priority Data
Feb. 20, 2013 (KR) 10-2013-0017956

(51) Int. Cl. B62D 15/02

(52) U.S. Cl. CPC B62D 15/0285
USPC 701/23

(57) ABSTRACT

Disclosed herein are an apparatus and method for automatically parking a vehicle. The apparatus for automatically parking a vehicle includes a location/heading information provision unit and a parking algorithm computation unit. The location/heading information provision unit calculates the corrected distances of movement of first and second wheels of the vehicle from the time at which parking is started using a plurality of correction factors that are calculated during a movement in any one of forward and rearward headings and during determination of a parking space, and calculates the changes in a heading and location of the vehicle using the corrected distances of movement. The parking algorithm computation unit generates a vehicle control signal intended to automatically park the vehicle in the parking space based on the changes in the heading and location of the vehicle.

### CROSS-REFERENCE TO RELATED APPLICATION

This application claims the benefit of Korean Patent Application No. 10-2013-0017956, filed on Feb. 20, 2013, which is hereby incorporated by reference in its entirety into this application.

### BACKGROUND OF THE INVENTION

1. Technical Field

The present invention relates generally to a parking assist system and an advanced driver assistance system, and particularly to technology that can determine the location and heading of a vehicle for parking and travelling by determining the relative distance and heading of the vehicle based on a preset location and automatically park the vehicle in a state in which a driver is not present in the vehicle.

2. Description of the Related Art

Various types of technology for supporting the convenience and safety of drivers, including a parking assist system and an advanced driver assistance system, have been applied to vehicles.

In particular, technology for enabling automatic unmanned parking has been introduced. Since parking requires the wider manipulation of the steering wheel of the vehicle and more frequent repetitions of forward and rearward driving than travelling, it is very important to accurately determine the current relative distance between a parking location and a vehicle and the heading of the vehicle in order to perform accurate unmanned parking.

Conventional technology for performing unmanned parking utilizes a high-performance Global Positioning System (GPS) and an Inertial Measurement Unit (IMU) in order to accurately determine the location and heading of a vehicle. However, these expensive apparatuses are great obstacles to the commercialization of unmanned automatic vehicle parking systems.

Korean Patent Application Publication No. 2006-0102016 discloses technology for the calibration of the inertial sensors of a car navigation system vehicle. Since this technology utilizes a GPS and inertial sensors, there is difficulty commercializing the technology as described above.

As a result, there is an urgent need for new automatic vehicle parking technology that can accurately determine the location and heading of a vehicle by determining a parking space without requiring an expensive GPS or IMU, and that can control the vehicle using the determined location and heading.

### SUMMARY OF THE INVENTION

Accordingly, the present invention is intended to provide an apparatus and method for automatically parking a vehicle that can accurately determine the location and heading of a vehicle by determining a parking space without requiring an expensive GPS or IMU, and that can automatically control the vehicle using the determined location and heading.

In addition, the present invention is intended to provide an apparatus and method for automatically parking a vehicle that can calculate distance correction factors while determining a parking space, and that can more accurately calculate the location and heading of the vehicle by correcting errors in the measurement of the distances by taking into account the correction factors upon measuring the distance of movement of the vehicle, thereby enabling accurate vehicle control even in the state in which a driver is not present in the vehicle.

In accordance with an aspect of the present invention, there is provided an apparatus for automatically parking a vehicle, including a location/heading information provision unit configured to calculate the corrected distances of movement of first and second wheels of the vehicle from the time at which parking is started using a plurality of correction factors that are calculated during a movement in any one of forward and rearward headings and during determination of a parking space, and to calculate the changes in the heading and location of the vehicle using the corrected distances of movement; and a parking algorithm computation unit configured to generate a vehicle control signal intended to automatically park the vehicle in the parking space based on the changes in the heading and location of the vehicle.

The corrected distances of movement may be calculated using the distances of movement of the first and second wheels that are measured by sensors mounted on the first and second wheels; and the correction factors may correspond to the first and second wheels, respectively.

The first and second wheels may be two rear wheels of the vehicle.

The correction factors may correspond to preset distances that have been divided by the distances of movement of the first and second wheels that are calculated during the determination of the parking space.

The corrected distances of movement may be calculated by multiplying the distances of movement of the first and second wheels by the correction factors that correspond to the distances of movement, respectively.

The change in the heading of the vehicle may be proportional to the difference between the corrected distances of movement, and may be inversely proportional to the distance between the first and second wheels.

The change in the location of the vehicle may correspond to a rotation by an angle that corresponds to the change in the heading.

The changes in the heading and location of the vehicle may be calculated based on each of preset locations that are present on map data.

The vehicle may perform unmanned automatic traveling based on the preset locations.

The correction factors may be updated at each of the preset locations.

In accordance with another aspect of the present invention, there is provided a method of automatically parking a vehicle, including calculating a plurality of correction factors while moving in any one of forward and rearward headings and, simultaneously, determining a parking space; calculating the distances of movement of first and second wheels of the vehicle from the time at which parking is started; calculating the corrected distances of movement by applying the correction factors to the distances of movement; calculating a change in a heading of the vehicle using the corrected distances of movement; calculating a change in a location of the vehicle using the corrected distances of movement; and generating a vehicle control signal intended to automatically park the vehicle in the parking space based on the changes in the heading and location of the vehicle.

The distances of movement may be calculated by sensors that are mounted on the first and second wheels, respectively; and the correction factors may correspond to the first and second wheels, respectively.

The first and second wheels may be two rear wheels of the vehicle.

The correction factors may correspond to preset distances that have been divided by the distances of movement of the first and second wheels that are calculated during the determination of the parking space.

The corrected distances of movement may be calculated by multiplying the distances of movement by the correction factors that correspond to the distances of movement, respectively.

The change in the heading of the vehicle may be proportional to the difference between the corrected distances of movement, and may be inversely proportional to the distance between the first and second wheels.

The change in the location of the vehicle may correspond to a rotation by an angle that corresponds to the change in the heading.

The changes in the heading and location of the vehicle may be calculated based on each of preset locations that are present on map data.

The vehicle may perform unmanned automatic traveling based on the preset locations.

The correction factors may be updated at each of the preset locations.

### BRIEF DESCRIPTION OF THE DRAWINGS

The above and other objects, features and advantages of the present invention will be more clearly understood from the following detailed description taken in conjunction with the accompanying drawings, in which:

FIG. 1 is a block diagram illustrating an apparatus for automatically parking a vehicle according to an embodiment of the present invention;

FIG. 2 is a diagram illustrating a process in which the apparatus for automatically parking a vehicle, which is illustrated in FIG. 1, calculates changes in the location and heading of the vehicle;

FIG. 3 is a block diagram illustrating an apparatus for automatically parking a vehicle according to another embodiment of the present invention;

FIG. 4 is a diagram illustrating the calculation of changes in heading and location and the update of a correction factor, which are performed based on a feature point; and

FIG. 5 is a flowchart illustrating a method of automatically parking a vehicle according to an embodiment of the present invention.

### DESCRIPTION OF THE PREFERRED EMBODIMENTS

The present invention will be described in detail below with reference to the accompanying drawings. Repeated descriptions and descriptions of known functions and configurations which have been deemed to make the gist of the present invention unnecessarily vague will be omitted. The embodiments of the present invention are intended to fully describe the present invention to a person having ordinary knowledge in the art. Accordingly, the shapes, sizes, etc. of elements in the drawings may be exaggerated to make the description clear.

Embodiments of the present invention will be described in detail with reference to the accompanying drawings.

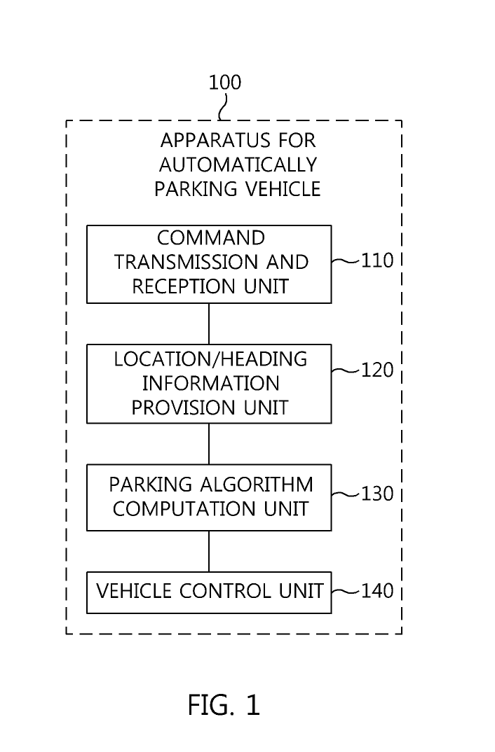

FIG. 1 is a block diagram illustrating an apparatus 100 for automatically parking a vehicle according to an embodiment of the present invention.

Referring to FIG. 1, the apparatus 100 for automatically parking a vehicle according to this embodiment of the present invention includes a command transmission and reception unit 110, a location/heading information provision unit 120, a parking algorithm computation unit 130, and a vehicle control unit 140.

The command transmission and reception unit 110 receives a parking-related command from a user terminal or a vehicle terminal, and transmits related feedback.

For example, the parking-related command may be a parking start command, an emergency stop command, a parking termination command, etc.

The location/heading information provision unit 120 obtains data from space search sensors and vehicle movement-related sensors, determines a parking space, generates the relative locations of the parking space and the vehicle, generates relative heading information while parking is being performed, and transfers the results of the generation to the parking algorithm computation unit 130. In this case, the space search sensors may be ultrasonic sensors, image sensors, laser scanners or the like. In this case, the vehicle movement-related sensors may be steering wheel angle sensors, wheel speed sensors, encoders or the like.

That is, the location/heading information provision unit 120 calculates the corrected distances of movement of the first and second wheels of the vehicle from the time at which parking is started using the plurality of correction factors that are calculated during a movement in any one of forward and rearward headings and the determination of the parking space, and calculates changes in the heading and location of the vehicle using the corrected distances of movement. In this case, the first and second wheels may be all the rear wheels of the vehicle.

The parking algorithm computation unit 130 generates a vehicle control command to park the vehicle in the parking space using the current location and heading information of the vehicle, and transmits the vehicle control command to the vehicle control unit 140.

That is, the parking algorithm computation unit 130 generates a vehicle control signal intended to automatically park the vehicle in the parking space based on changes in heading and location, which are calculated by the location/heading information provision unit 120.

The vehicle control unit 140 performs vehicle control, such as steering wheel control, deceleration/acceleration control, transmission control and the like based on the received vehicle control command, thereby actually moving the vehicle so that the vehicle can be parked.

The flow of automatic parking that is performed using the apparatus for automatically parking a vehicle illustrated in FIG. 1 will be described below.

After a vehicle has been parked near a location where the vehicle needs to be parked, a driver gets out of the vehicle.

The driver who has gotten out of the vehicle transmits an automatic parking command to an automatic parking apparatus inside the vehicle using the user terminal or vehicle terminal.

The vehicle determines a parking space using space search sensors (for example, ultrasonic sensors, image sensors, laser scanners, or the like) while moving forward. In this case, the heading of movement of the vehicle may be adjusted so that the vehicle is prevented from colliding with one or more vehicles around the parking space. While the parking space is being determined, the state of one or more obstacles, the state of one or more traffic lanes, records of steering wheel control, changes in the wheel speeds of both wheels, etc. are continuously recorded.

A movement distance correction factor is calculated using continuously recorded values.

Once the movement distance correction factor has been successfully calculated and the parking space has been successfully determined, automatic parking is started.

The present invention performs automatic parking while adjusting a steering wheel and the distance using the current relative distance between a parking target location and the vehicle and heading. In this case, the current location and heading of the vehicle is determined using the distance of movement of the vehicle calculated by the wheel speed sensors and the movement distance correction factor previously calculated.

After parking has been completed, parking completion information is transmitted to the user terminal.

The present invention may calculate the movement distance correction factors while determining the parking space.

The distance of movement of the vehicle may be calculated using wheel speed sensors or encoders that are mounted on respective wheels of the vehicle.

In the case of the wheel speed sensors, the distance may be calculated by multiplying the time taken to move by the speed measured. In the case of the encoders, the distance of movement may be determined using the size of the wheels, encoder values output when the wheels make one rotation, and encoder values output when the vehicle moves. When two rear wheel speed sensors of the vehicle are used to measure the distance of movement of the vehicle, the average of the distances of movement that are calculated using the two wheel speed sensors may be used.

If data that is measured by wheel speed sensors or encoders is used without correction when the distance of movement is calculated using the wheel speed sensors or encoders mounted on wheels, errors attributable to factors, such as the sizes of the wheels of the vehicle, tire air-pressure states, external temperature and/or the like, may be serious problems. In order to reduce such errors, the present invention calculates movement distance correction factors while determining a parking space, and corrects measured values using the calculated movement distance correction factors, thereby being able to reduce the errors that occur when the distance of movement of the vehicle is calculated.

Furthermore, the present invention calculates the distance of movement of the vehicle using wheels that are not steered. Generally, since the front wheels of the vehicle are steered and the rear wheels thereof are not steered, the distance of movement of the vehicle may be calculated using the rear wheels of the vehicle.

Although the movement distance correction factors may be calculated using various methods, a case where the movement distance correction factors are calculated using the following method will be described as an example.

Ultrasonic sensors are mounted on the front and rear wheels of a vehicle, respectively.

While a parking space is being determined using the ultrasonic sensors, the distances of movement start to be recorded using wheel speed sensors from the time at which the front ultrasonic sensors detect an obstacle and then the disappearance of the obstacle.

The distances of movement of both wheels are recorded until the vehicle moves forward and the rear ultrasonic sensors detect the obstacle and then the disappearance of the obstacle. This enables the distances of movement of both wheels and the actual distance of movement to be determined. The distances of movement A_{raw} and B_{raw} are calculated by multiplying the speed calculated by the wheel speed sensors, by time. The actual distance N of movement is the distance between the front ultrasonic sensors and the rear ultrasonic sensors.

The movement distance correction factors k1 and k2 of the two rear wheels of the vehicle are calculated using Equations 1 and 2:

$$\begin{matrix}k 1 = \frac{N}{{A}_{raw}} & ( 1 ) \\ k 2 = \frac{N}{{B}_{raw}} & ( 2 )\end{matrix}$$

Although the case where the distances of movement are calculated using the ultrasonic sensors has been described as an example, the actual distance N of movement and the distances of movement may be obtained using sensors other than the ultrasonic sensors in a similar manner. If there is a manipulation of a steering wheel during the determination of a parking space, compensation for the manipulation may be performed.

In the present invention, the changes in the location and heading of the vehicle may be calculated using the distances of movement and correction factors of the wheels.

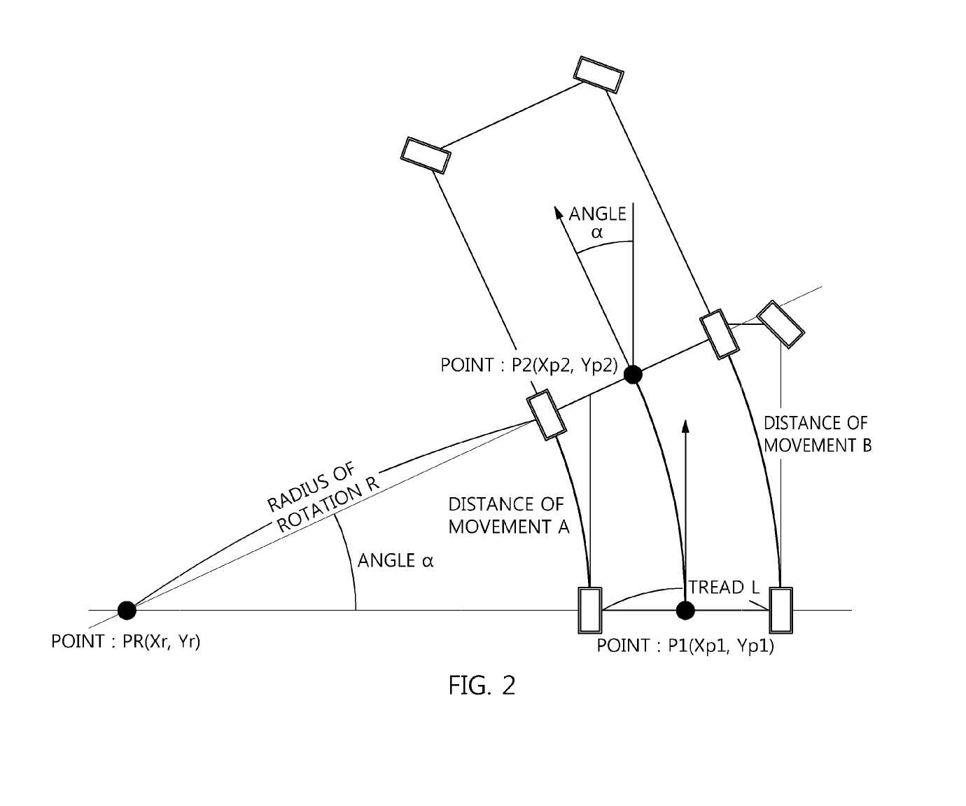

FIG. 2 is a diagram illustrating a process in which the apparatus for automatically parking a vehicle, which is illustrated in FIG. 1, calculates changes in the location and heading of the vehicle. The example illustrated in FIG. 2 illustrates the calculation of changes in the location and heading of the vehicle during a unit time.

The descriptions of the variables illustrated in FIG. 2 are as follows:

R: a radius of rotation when the vehicle rotates

μI: an angle of rotation when the vehicle rotates (unit: degrees)

PR (Xr, Yr): the coordinates X and Y of the center of a rotation circle when the vehicle rotates

L: the length of the shaft of the rear wheels of the vehicle

A: the distance of movement of the left wheel

B: the distance of movement of the right wheel

P1 (Xp1, Yp1): the coordinates X and Y of the center of the shaft of the rear wheels of the vehicle before rotation

P2 (Xp2, Yp2): the coordinates X and Y of the center of the shaft of the rear wheels of the vehicle after rotation

Referring to FIG. 2, a change in the heading may be calculated using the following Equation 3 and 4:

$$\begin{matrix}2 * π * R * ( \frac{α}{360} ) = A & ( 3 ) \\ 2 * π * ( R + L ) * ( \frac{α}{360} ) = B & ( 4 )\end{matrix}$$

By rearranging Equations 3 and 4 with respect to μ, the following Equation 5 is obtained:

$$α = ( B - A ) * \frac{360}{2 π L} \qquad ( 5 )$$

Since the length L of the shaft of the rear wheels of the vehicle is determined based on the specifications of the vehicle upon manufacturing the vehicle in Equation 5, the angle μ of rotation when the vehicle rotates is calculated when only the distances A and B of movement of the wheels are measured. That is, the accuracy of the change in the heading is determined depending on the accuracy of the distances A and B of movement of the wheels.

In the present invention, the movement distance correction factors are used to increase the accuracy of measurement of the distances A and B of movement of the wheels. That is, in the present invention, the distances A and B of movement of the wheels are corrected using the following Equation 6:

A=k1*A_{raw}

B=k2*B_{raw} (6)

A_{raw}: the distance of movement calculated from the sensor of the left wheel

B_{raw}: the distance of movement calculated from the sensor of the right wheel

k1: the movement distance correction factor of the left wheel

k2: the movement distance correction factor of the right wheel

As described above, the movement distance correction factors k1 and k2 are calculated while a parking space is being determined.

The change in the location of the vehicle may be calculated from the change in the heading thereof. The value P2 (Xp2, Yp2) of the change in the center of the shaft of the vehicle may be viewed as being obtained by rotating P1 (Xp1, Yp1) by a around the center PR (Xr, Yr) of a circle having radius (R+L/2). The coordinate values after the change in the location may be calculated using Equation 7:

$$( \begin{matrix}Xp 2 \\ Yp 2\end{matrix} ) = ( \begin{matrix}cos ( α ) & - sin ( α ) \\ sin ( α ) & cos ( α )\end{matrix} ) ( \begin{matrix}Xp 1 - Xr \\ Yp 1 - Yr\end{matrix} ) + ( \begin{matrix}Xr \\ Yr\end{matrix} ) \qquad ( 7 )$$

Furthermore, the apparatus for automatically parking a vehicle according to the present invention may perform automatic traveling in a specific interval while operating in conjunction with map data.

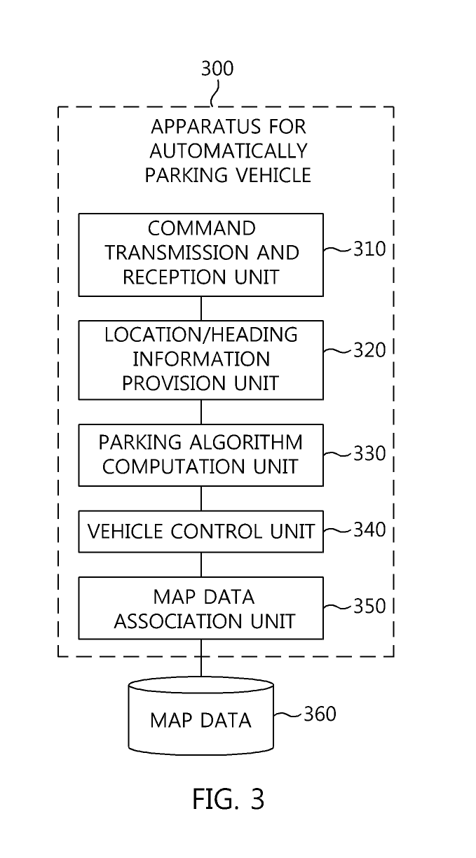

FIG. 3 is a block diagram illustrating an apparatus 300 for automatically parking a vehicle according to another embodiment of the present invention.

Referring to FIG. 3, the apparatus 300 for automatically parking a vehicle according to this embodiment of the present invention includes a command transmission and reception unit 310, a location/heading information provision unit 320, a parking algorithm computation unit 330, a vehicle control unit 340, and a map data association unit 350.

Since the command transmission and reception unit 310, the location/heading information provision unit 320, the parking algorithm computation unit 330 and the vehicle control unit 340 have already been described with reference to FIG. 1, detailed descriptions thereof will be omitted.

The map data association unit 350 enables the apparatus 300 for automatically parking a vehicle to detect the relative location and heading of the vehicle based on a specific location of a map while operating in conjunction with map data 360.

Hereinafter, a specific location that is present on the map data 360 is referred to as a “feature point.”

Since the apparatus 300 for automatically parking a vehicle, which is illustrated in FIG. 3, may determine the relative location and the heading based on the feature point, the vehicle may travel a specific distance via dead reckoning navigation.

Accordingly, if the vehicle travels while continuously switching between feature points present on the map data 360, unmanned automatic traveling may be performed within a space in which feature points are present.

In this case, each feature point may be an object, a symbol or a mark that can be identified using a sensor, such as a mark or a number on a pole, a wall, or a road. For example, the feature point may be a pole of a parking lot, a number of a parking lot, a speed bump, an arrow on a road, an exit sign, or the like.

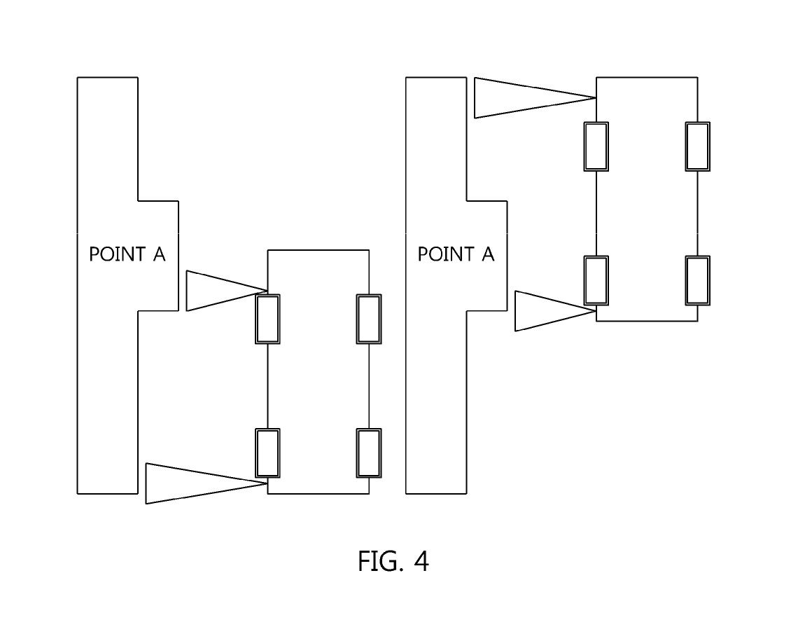

FIG. 4 is a diagram illustrating the calculation of changes in heading and location and the update of a correction factor, which are performed based on a feature point.

Referring to FIG. 4, point A feature is a point that is included in map data.

When a vehicle passes by the feature point, that is, point A, the vehicle may calculate relative distance and heading with respect to point A. Furthermore, the movement distance correction factors of the wheel speed sensors of the vehicle may be updated based on point A, thereby enabling more accurate measurement of locations and headings.

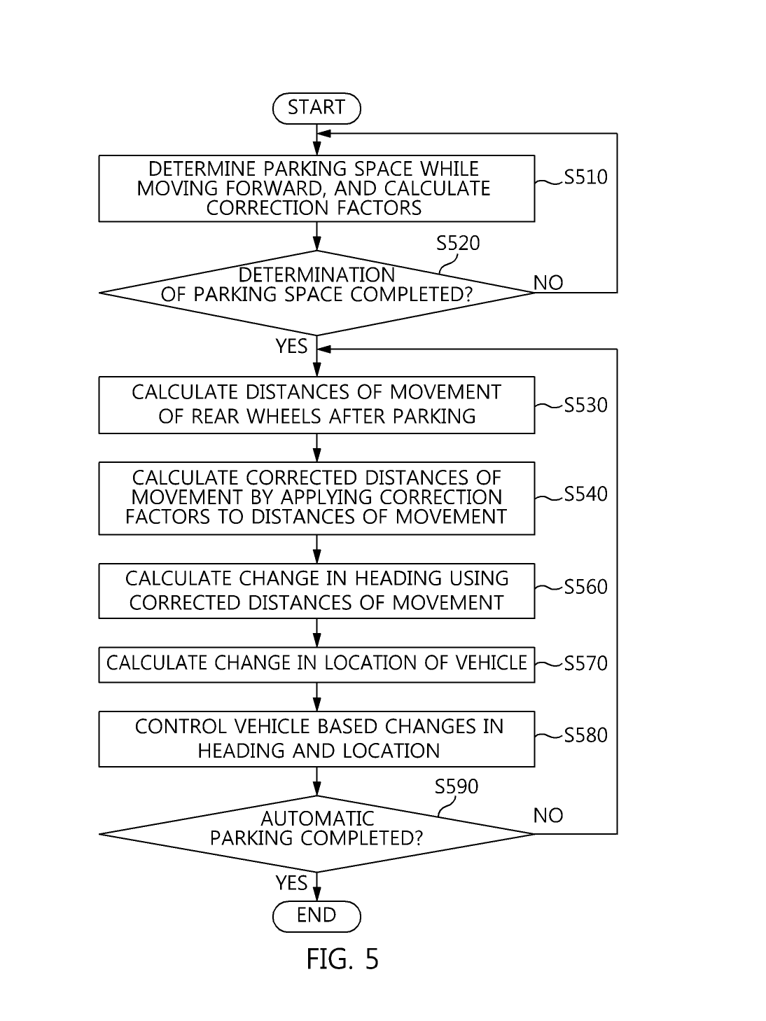

FIG. 5 is a flowchart illustrating a method of automatically parking a vehicle according to an embodiment of the present invention.

Referring to FIG. 5, the method of automatically parking a vehicle according to this embodiment of the present invention determines a parking space and also calculates a plurality of correction factors while a vehicle is moving forward at step S510.

In this case, the method of automatically parking a vehicle may determine a parking space and also calculate a plurality of correction factors while a vehicle is moving rearward.

In this case, the correction factors may be calculated using Equation 1 and 2.

Furthermore, the method of automatically parking a vehicle determines whether the parking space has been determined at step S520.

If, as a result of the determination at step S520, it is determined that the parking space has not been determined, the method of automatically parking a vehicle returns to step S510.

If, as a result of the determination at step S520, it is determined that the parking space has been determined, the method of automatically parking a vehicle calculates the distances of movement of the two rear wheels of the vehicle from the starting time point of parking at step S530.

In this case, the distances of movement may be measured by the sensors mounted on the rear wheels, and the correction factors may correspond to the rear wheels, respectively.

Furthermore, the method of automatically parking a vehicle calculates corrected distances of movement by applying the correction factors to the distances of movement at step S540.

In this case, the corrected distances of movement may be calculated using Equation 6. That is, the corrected distances of movement may be calculated by multiplying the distances of movement calculated at step S530 by the correction factors corresponding to the distances of movement, respectively.

Furthermore, the method of automatically parking a vehicle calculates a change in heading using the corrected distances of movement at step S560.

In this case, the change in heading may be calculated using Equation 5. That is, the change in heading may be proportional to the difference between the corrected distances of movement, and may be inversely proportional to the distance between the rear wheels.

Furthermore, the method of automatically parking a vehicle calculates a change in the location of the vehicle using the corrected distances of movement at step S570.

In this case, the change in the location of the vehicle may correspond to rotational movement around an angle that corresponds to the change in the heading.

In this case, the changes in the heading and location of the vehicle may be calculated based on preset locations that are present on the map data.

In this case, the vehicle may perform unmanned automatic traveling based on the preset locations, and the correction factors may be updated at each of the preset locations.

Furthermore, the method of automatically parking a vehicle generates a vehicle control signal intended to automatically park the vehicle in the parking space based on the changes in heading and location at step S580.

Furthermore, the method of automatically parking a vehicle determines whether automatic parking has been completed at step S590.

If, as a result of the determination at step S590, it is determined that the automatic parking has not been completed, the method of automatically parking a vehicle returns to step S510.

If, as a result of the determination at step S590, it is determined that the automatic parking has been completed, the method of automatically parking a vehicle terminates the process.

The apparatus and method for automatically parking a vehicle according to the present invention can accurately determine the location and heading of a vehicle by determining a parking space without requiring an expensive GPS or IMU, and can automatically control the vehicle using the determined location and heading.

Furthermore, the apparatus and method for automatically parking a vehicle according to the present invention can calculate distance correction factors while determining a parking space, and can more accurately calculate the location and heading of the vehicle by correcting errors in the measurement of the distances by taking into account the correction factors upon measuring the distance of movement of the vehicle, thereby enabling accurate vehicle control even in the state in which a driver is not present in the vehicle.

Although the preferred embodiments of the present invention have been disclosed for illustrative purposes, those skilled in the art will appreciate that various modifications, additions and substitutions are possible, without departing from the scope and spirit of the invention as disclosed in the accompanying claims.

What is claimed is:

1. An apparatus for automatically parking a vehicle, comprising:
a location/heading information provision unit configured to calculate corrected distances of movement of first and second wheels of the vehicle from a time at which parking is started using a plurality of correction factors that are calculated during a movement in any one of forward and rearward headings and during determination of a parking space, and to calculate changes in a heading and location of the vehicle using the corrected distances of movement; and
a parking algorithm computation unit configured to generate a vehicle control signal intended to automatically park the vehicle in the parking space based on the changes in the heading and location of the vehicle.

2. The apparatus of claim 1, wherein:
the corrected distances of movement are calculated using distances of movement of the first and second wheels that are measured by sensors mounted on the first and second wheels; and
the correction factors correspond to the first and second wheels, respectively.

3. The apparatus of claim 2, wherein the first and second wheels are two rear wheels of the vehicle.

4. The apparatus of claim 3, wherein the correction factors correspond to preset distances that have been divided by the distances of movement of the first and second wheels that are calculated during the determination of the parking space.

5. The apparatus of claim 4, wherein the corrected distances of movement are calculated by multiplying the distances of movement of the first and second wheels by the correction factors that correspond to the distances of movement, respectively.

6. The apparatus of claim 5, wherein the change in the heading of the vehicle is proportional to a difference between the corrected distances of movement, and is inversely proportional to a distance between the first and second wheels.

7. The apparatus of claim 6, wherein the change in the location of the vehicle corresponds to a rotation by an angle that corresponds to the change in the heading.

8. The apparatus of claim 7, wherein the changes in the heading and location of the vehicle are calculated based on each of preset locations that are present on map data.

9. The apparatus of claim 8, wherein the vehicle performs unmanned automatic traveling based on the preset locations.

10. The apparatus of claim 9, wherein the correction factors are updated at each of the preset locations.

11. A method of automatically parking a vehicle, comprising:
calculating a plurality of correction factors while moving in any one of forward and rearward headings and, simultaneously, determining a parking space;
calculating distances of movement of first and second wheels of the vehicle from a time at which parking is started;
calculating corrected distances of movement by applying the correction factors to the distances of movement;
calculating a change in a heading of the vehicle using the corrected distances of movement;
calculating a change in a location of the vehicle using the corrected distances of movement; and
generating a vehicle control signal intended to automatically park the vehicle in the parking space based on the changes in the heading and location of the vehicle.

12. The method of claim 11, wherein:
the distances of movement are calculated by sensors that are mounted on the first and second wheels, respectively; and
the correction factors correspond to the first and second wheels, respectively.

13. The method of claim 12, wherein the first and second wheels are two rear wheels of the vehicle.

14. The method of claim 13, wherein the correction factors correspond to preset distances that have been divided by the distances of movement of the first and second wheels that are calculated during the determination of the parking space.

15. The method of claim 14, wherein the corrected distances of movement are calculated by multiplying the distances of movement by the correction factors that correspond to the distances of movement, respectively.

16. The method of claim 15, wherein the change in the heading of the vehicle is proportional to a difference between the corrected distances of movement, and is inversely proportional to a distance between the first and second wheels.

17. The method of claim 16, wherein the change in the location of the vehicle corresponds to a rotation by an angle that corresponds to the change in the heading.

18. The method of claim 17, wherein the changes in the heading and location of the vehicle are calculated based on each of preset locations that are present on map data.

19. The method of claim 18, wherein the vehicle performs unmanned automatic traveling based on the preset locations.

20. The method of claim 19, wherein the correction factors are updated at each of the preset locations.
